(19) United States
(12) Patent Application Publication
(10) Pub. No.: US 2026/0365237 A1
(43) Pub. Date: Nov. 19, 2026

(54) METHOD FOR OPERATING A STEERING SYSTEM FOR A VEHICLE, STEERING SYSTEM FOR A VEHICLE, AND VEHICLE

(71) Applicant: Ford Global Technologies, LLC, Dearborn, MI (US)

(72) Inventors: Sergio Codonesu, Aachen (DE); Oliver Nehls, Düsseldorf (DE); David Michael Russell, Ann Arbor, MI (US); Alexander Ein Waldt, Köln (DE)

(21) Appl. No.: 19/664,527

(22) Filed: Apr. 30, 2026

(30) Foreign Application Priority Data
May 19, 2025 (DE) 102025119271.5

(51) Int. Cl. B62D 6/00; B62D 5/00; B62D 5/04

(52) U.S. Cl. CPC B62D 6/008; B62D 5/006; B62D 5/0421

(57) ABSTRACT

Methods and apparatus for operating a steering system for a vehicle, to a steering system for a vehicle, and to a vehicle. A disclosed apparatus for operating a steering system for a vehicle including interface circuitry communicatively coupled to a sensor, machine readable instructions, and at least one programmable circuitry to execute the machine readable instructions to determine an occurrence of a change of driving mode in which control of a steering wheel is to be transferred between a driving control device and driver input, and in response to an output of the sensor corresponding to a steering command imparted to the steering wheel or a change in the steering command, provide, based on the change of driving mode, a control signal that is adapted relative to a normal operating mode of the steering system to at least one of (i) a road wheel actuator to reduce a road wheel angle in relation to the normal operating mode, or (ii) a steering wheel actuator to provide an increased feedback torque in relation to the normal operating mode.

### RELATED APPLICATION

This patent claims priority from DE Patent Application Number 102025119271.5, which was filed on May 19, 2025, and is hereby incorporated herein by reference in its entirety.

### FIELD OF THE DISCLOSURE

The disclosure relates to methods and apparatus for operating a steering system for a vehicle, to a steering system for a vehicle, and to a vehicle.

### BACKGROUND

Vehicles are increasingly being equipped with advanced functions which control the path of the vehicle independently of the driver. Examples of these are level 2+ functions (e.g., lane keeping, lane centring) and level 3/4 functions (e.g., autonomous driving). These types of functions are referred to as “lane following functions.” While the vehicle is in the lane following mode, the steering wheel rotates synchronously with the wheels and with a steering ratio unchanged in relation to the manual mode, or the steering wheel rotates only with a reduced amplitude (also referred to as whisper mode), or the steering wheel does not rotate (also referred to as idle mode).

### SUMMARY

An example apparatus for operating a steering system for a vehicle includes interface circuitry communicatively coupled to a sensor, machine readable instructions, and at least one programmable circuitry to execute the machine readable instructions to determine an occurrence of a change of driving mode in which control of a steering wheel is to be transferred between a driving control device and driver input, and in response to an output of the sensor corresponding to a steering command imparted to the steering wheel or a change in the steering command, provide, based on the change of driving mode, a control signal that is adapted relative to a normal operating mode of the steering system to at least one of (i) a road wheel actuator to reduce a road wheel angle in relation to the normal operating mode, or (ii) a steering wheel actuator to provide an increased feedback torque in relation to the normal operating mode.

An example method for operating a steering system for a vehicle includes determining an occurrence of a change of driving mode in which control of a steering wheel is to be transferred between a driving control device and driver input, and in response to an output of a sensor corresponding to a steering command imparted to the steering wheel or a change in the steering command, providing, based on the change of driving mode, a control signal that is adapted relative to a normal operating mode of the steering system to at least one of (i) a road wheel actuator to reduce a road wheel angle in relation to the normal operating mode, or (ii) a steering wheel actuator to provide an increased feedback torque in relation to the normal operating mode.

An example non-transitory machine readable storage medium includes instructions to cause at least one programmable circuitry to at least determine an occurrence of a change of driving mode in which control of a steering wheel of a vehicle is to be transferred between a driving control device and driver input, and in response to an output of a sensor corresponding to a steering command imparted to the steering wheel or a change in the steering command, provide, based on the change of driving mode, a control signal that is adapted relative to a normal operating mode of a steering system to at least one of (i) a road wheel actuator to reduce a road wheel angle in relation to the normal operating mode, or (ii) a steering wheel actuator to provide an increased feedback torque in relation to the normal operating mode.

### BRIEF DESCRIPTION OF THE DRAWINGS

Examples disclosed herein and further advantageous examples and developments thereof will be explained and described in more detail below with reference to the examples illustrated in the drawings. In the drawings:

FIG. 1 is a schematic illustration of a vehicle according to examples disclosed herein having a steering system according to examples disclosed herein.

FIG. 2 is a schematic illustration of a method according to examples disclosed herein for operating a steering system for a vehicle.

FIG. 3 is a schematic illustration of a progression of the road wheel angle of a steerable road wheel during the course of the method according to examples disclosed herein.

FIG. 4 is a block diagram of an example processing platform including programmable circuitry structured to execute, instantiate, and/or perform the example machine-readable instructions and/or perform the example operations of FIG. 2 to implement electronic steering systems and/or components thereof disclosed herein.

### DETAILED DESCRIPTION

Methods and apparatus for operating a steering system for a vehicle, to a steering system for a vehicle, and to a vehicle are disclosed. Depending on an autonomy level of a vehicle, the driver must monitor the road and traffic conditions and be ready at all times to take manual control of a steering wheel if a fault is identified in a system, or if road conditions require manual driving, for example. The driver may also themselves decide to take over control, that is to say without any prompting or notification from the system. Since the driver must adjust from merely observing to actively controlling the vehicle, they may cause relatively large or abrupt steering wheel inputs. This can lead to unpleasant vehicle movements and increased complexity in controlling the vehicle on the desired course, in particular in the initial phase of the takeover by the driver. This discrepancy is exacerbated if the steering ratio is not direct and/or the steering torque is relatively low. In such cases, it can be difficult for the driver to seamlessly take over control without an abrupt change in steering behavior.

US 2020 0 406 964 A1 discloses a method and a system for vehicle steering control, which comprises the control of a feedback torque actuator in series with an angle superposition actuator in a vehicle steering system. The feedback torque actuator is controlled such that a target feedback torque is achieved. The angle superposition actuator is controlled such that a target superposition angle is achieved. The angle superposition actuator is controlled such that a variable steering ratio and an additional superposition angle are provided. The torque feedback actuator is controlled using a reference generator such that the torque is controlled in such a way as to achieve a setpoint steering feel.

Examples disclosed herein can provide a steering system and a method for operating same, by which the transition between an autonomous or semi-autonomous driving mode and a manual driving mode is made more comfortable than has hitherto been possible.

Advantageous examples are indicated in the following description, wherein each example, individually or in (sub)combination, can constitute aspects of examples disclosed herein.

Accordingly, examples disclosed herein include a method for operating a steering system for a vehicle can be advantageous in providing a steering interface. The steering system has at least a road wheel actuator (RWA), a steering wheel actuator (FBA, “feedback actuator”), a steering wheel, a steering wheel sensor, and a control device coupled to the RWA, to the FBA and at least indirectly to the steering wheel. The method comprises at least the following steps:
a change of driving mode, in which control of the steering by the steering wheel is to be transferred from a driving control device to a driver of the vehicle or is taken over by the driver, is determined or received by the control device,
   and:
a control signal which has been adapted in relation to a normal operating mode of the steering system is output from the control device to an electric motor of the RWA such that a steering command (e.g., a steering specification) imparted by the steering wheel, or a change in steering command, results in a smaller road wheel angle in relation to the normal operating mode, or a reduced change in road wheel angle, of a steerable road wheel of the vehicle,
   and/or:
a control signal which has been adapted in relation to a normal operating mode of the steering system is output from the control device to an electric motor of the FBA such that a steering command imparted by the steering wheel, or a change in steering command, results in an increased feedback torque in relation to the normal operating mode, or an increased change in feedback torque, at the steering wheel.

Examples disclosed herein are based on the recognition that different measures can be implemented to make the transition of the driving mode change as uniform as possible. For this purpose, the control signals which are output to an electric motor, either of the RWA or of the FBA, can be adapted in a manner tailored to the situation. Owing to the smaller road wheel angle in relation to the steering command, or the smaller corresponding change of the road wheel angle, a slower reaction is achieved with regard to the lateral guidance of the vehicle in relation to the steering command. This has the effect that the steering input made by the driver is also smoother than without the method, thereby enabling a smaller difference between the actual vehicle trajectory and the setpoint trajectory. In the alternative case, in which the feedback torque for the driver is reduced or the change is diminished, a reduced steering input by the driver upon the driving mode change, and the associated changes in the lateral guidance, can also be achieved. Therefore, this can also lead to a smaller difference between the actual vehicle trajectory and the setpoint trajectory.

Altogether, the example method enables the vehicle to be controlled in accordance with demand upon the transition from semi-autonomous autonomous driving to manual driving. At the same time, a reduced driving path difference and increased running smoothness of the vehicle are achieved. This increases comfort for the driver. Since the effects of the driving mode change are diminished, a driving mode change is possible even in dynamic driving situations. Furthermore, owing to the diminished effects of the driving mode change, the method allows greater freedom for fine-tuning, for example with regard to the steering ratio. The variability in the operation of the steering system is, thus, increased.

Optionally, the control signal can be adapted in relation to the normal operating mode is based on the control device receiving the steering command, which has been imparted by the steering wheel, and determining the adapted control signal by virtue of the control device:
taking into account a steering ratio which has been adapted in relation to the normal operating mode, and/or
taking into account a time delay of the road wheel angle, corresponding to the steering command, of the steerable road wheel, and/or
taking into account a time delay of the steering command, and/or
taking into account a feedback torque parameterization which has been adapted in relation to the normal operating mode, and/or
   taking into account a damping torque, which is additional or has been adapted in relation to the normal operating mode, at the steering wheel.

The steering ratio corresponds to the road wheel angle (and/or a toothed rack position, influenced by the RWA, of a toothed rack and/or a pinion position of a pinion) varying dynamically in accordance with the steering wheel angle and/or the steering wheel speed and vice versa. The steering ratio is generally variable (variable steering ratio), such that it can have different dependency ratios for different parameter ranges. For example, in particular for small deflections of the steering wheel from the reference position (straight-ahead position), the road wheel angle may be linearly dependent on the deflection of the steering wheel. For greater deflections of the steering wheel in relation to the reference position, a transition to a non-linear dependency ratio may generally be taken into account.

The adapted or additional damping torque counteracts the steering inputs made by the driver.

By the adapted steering ratio, disadvantageous abrupt changes in the road wheel angle owing to the initial abrupt steering wheel movement by the driver are mitigated and dampened. The result is that the vehicle deviates less from the intended path and responds less abruptly to possible overcorrections by the driver, such that it is easier for the driver to laterally control the vehicle as desired. Tailored fine-tuning of the steering movements is consequently achieved, thereby leading to more precise control and more comfortable handling of the vehicle.

Owing to the time delay of the road wheel angle, sudden steering movements are dampened, which can contribute to increased driving stability, in particular at relatively high speeds.

The adapted feedback torque parameterization allows optimization of the haptic feedback for the driver, allowing adapted control by the driver for the lateral guidance. Accordingly, precision is increased during the takeover of the control of the vehicle.

The adapted or additional damping torque ensures that the overcorrections by the driver are reduced. As a result, increased driving comfort and an adapted driving feel are enabled.

In some examples, a time delay of the road wheel angle, which corresponds to the steering command, or of the steering command is affected by a low-pass filter which is part of the control device or to which the control device is coupled. The low-pass filter can smooth the steering movements, leading to smoother and more stable travel, especially on uneven roads or at high speeds.

According to one aspect, the adapted steering ratio may be less direct than a steering ratio of the normal operating mode. Driving accuracy is thus increased, because the steering reacts less sensitively to steering commands imparted by the driver, allowing a more precise driving style.

The control signal which has been adapted in relation to the normal operating mode is preferably based on the control device taking into account at least one of:
a speed of the vehicle, and/or
   the steering ratio of the normal operating mode, and/or
a driver personalization function, and/or
   driving surface conditions experienced by the vehicle, and/or
a received steering wheel angle and/or a received steering wheel speed of the steering wheel.

By virtue of the vehicle speed being taken into account, the control of the steering system is adapted to the present driving situation, and vehicle control is, thus, enhanced. If the steering ratio of the normal operating mode is taken into account, the lateral guidance of the vehicle is adapted to a lateral guidance configuration with which the driver is familiar. The driver is then less surprised by a divergent behavior. The personalization enables the control signal to be configured on a driver-specific basis, which is advantageous for example if a vehicle is used by different drivers. The comfort and satisfaction of each driver are, thus, increased by virtue of the steering system being adapted to individual driving styles and preferences. Taking the driving surface conditions into account enables the lateral guidance to be optimized for different driving surfaces, whereby control and steering capability can be adapted in tailored fashion. By the steering wheel angle and/or the steering wheel speed, the steering command imparted by the driver can be taken into account more precisely.

The example driving control device is configured to perform autonomous or partially autonomous driving functionalities. Such driving functionalities are generally known, for example, with regard to an assisted parking maneuver. Autonomous driving functionalities can also relate to the guidance of the vehicle in normal road traffic. For example, autonomous driving functionalities may be provided for which a level of autonomy is allowed, according to which the driver of the vehicle may also take their eyes off the road. In this case, the driving control device drives the vehicle fully autonomously. Comfort for the driver of the vehicle can, thus, be particularly high.

The autonomous or partially autonomous driving functionality performed by the driving control device can cause the driving control device to output corresponding control signals to the control device of the steering system, on the basis of which the steering wheel is deflected, namely by the FBA, in accordance with a steering wheel angle specified by the control signal. This means that the actual control of the steering wheel angle of the steering wheel is performed by the control device of the steering system, which however receives corresponding information from the driving control device indicating how the steering wheel movement should be defined.

Alternatively or additionally, the driving control device may also output control signals for the control device of the steering system, on the basis of which an orientation of the steerable road wheels is adjusted.

In some examples, the method preferably comprises at least one of the following additional steps if the driving control device has control of the steering:

The steering wheel is moved, on the basis of a control signal which is output from the control device or the driving control device to the electric motor of the FBA, in accordance with a following mode in which the steering wheel angle corresponds to the road wheel angle taking into account the steering ratio.

The steering wheel is moved, on the basis of a control signal output from the control device or the driving control device to the electric motor of the FBA, in accordance with a whisper mode in which the steering wheel angle corresponds to the road wheel angle taking into consideration the steering ratio and a reduction factor. The reduction factor is less than 1.

A movement of the steering wheel is prevented by the control device or the driving control device in accordance with an idle mode. In the idle mode, the steering wheel is oriented in accordance with a reference angle (for example a straight-ahead position).

In the following example mode, the whisper mode and the idle mode of the steering wheel are advantageous in particular for autonomous or partially autonomous driving functionalities which are performed by the driving control device directly or by the steering system.

For example, the autonomy level of the autonomous driving function may be relatively high. If this is allowed, comfort for the driver of the vehicle can be increased by the idle mode of the steering wheel, because in this case the steering wheel is no longer moved. This means that the driver is not influenced by a moving steering wheel. In this case, the steering wheel is orientated in accordance with a reference angle, for example a straight-ahead position.

In an alternative example, in the following mode, the steering wheel follows the road wheel angle, which is dependent on the detected first measured variable, for example a detected road wheel angle or a detected toothed rack position, taking into account the steering ratio.

In an additional example, in the whisper mode, the steering wheel follows the road wheel angle, but with a reduced amplitude owing to the reduction factor. This means that a road wheel angle that would actually lead to a specific steering wheel angle of the steering wheel is taken into account by the FBA such that the FBA turns the steering wheel in accordance with a steering wheel angle that is smaller than the specific steering wheel angle defined by the road wheel angle taking into account the steering ratio. In other words, the steering wheel can be turned less than during normal operation (in the normal operating mode). This is ensured by the reduction factor, which is less than 1, for example.

At least in the idle mode and in the whisper mode, an offset is generated which can be compensated for, for example by continuous transitions.

If the control signal is based on a steering ratio being taken into account which has been adapted in relation to the normal operating mode, the method optionally comprises the following in a compensation phase after an adapted steering ratio has been taken into account:

An offset between a detected steering wheel angle of the steering wheel and a road wheel angle of at least one steerable road wheel which is at least indirectly coupled to the RWA, said offset being caused by the adapted steering ratio, is determined by the control device. The offset is dependent on a detected first measured variable taking into account the adapted steering ratio.

A steering wheel speed of the steering wheel caused by the steering wheel movement is detected by the steering wheel sensor.

During the compensation phase, a control signal is output to an electric motor of the RWA by the control device such that the determined offset is compensated for on the basis of a compensation function, which is dependent on the detected steering wheel speed, during a movement of at least one steerable road wheel caused by the steering wheel movement.

Alternatively or additionally, during the compensation phase:
the adapted steering ratio is changed in continuous fashion to the steering ratio of the normal operating mode, and/or
a time delay taken into account for the adapted control signal is reduced in continuous fashion to zero, and/or
the adapted feedback torque parameterization is changed in continuous fashion to a feedback torque parameterization of the normal operating mode, and/or
an adapted damping torque is changed in continuous fashion to a damping torque of the normal operating mode.

Although the change in the steering ratio makes it possible to mitigate and dampen abrupt changes in the road wheel angle owing to the initial abrupt steering wheel movement by the driver, the change in the steering ratio leads to an offset. Put simply, the changed steering ratio means that the steering wheel and steerable road wheel behave differently relative to one another than they would in the presence of the conventional steering ratio of the normal operating mode. This is manifest as an offset which must subsequently be reduced and eliminated so that the familiar comfortable steering feel can be provided to the driver. By the measures described above, the offset can in particular be reduced in continuous fashion, resulting in particularly high comfort for the driver.

By determining the offset, the effects of the situation-dependent properties of the steering system can be assessed more precisely to be able to implement tailored measures. The compensation function and/or the further exemplary measures have the effect that the offset is reduced in smooth and continuous fashion. The steering command imparted by the driver is nevertheless taken into account. Consistent steering behavior of the steering system is, thus, ensured.

Accordingly, this means that the offset can be compensated by a movement of at least one road wheel, despite the driver themselves or the driving control device itself causing movements of the steering wheel. In this case, the steering wheel speed of the movement of the steering wheel caused by the driver or the driving control device is taken into account by the control device. The offset is then compensated for by a function which is dependent on the steering wheel speed. This means that the control device can, at least temporarily, affect an actuation of at least one steerable road wheel which is overproportional or underproportional in relation to the movement of the road wheel actually caused by the movement of the steering wheel, such that the offset can be compensated for.

All approaches have the effect that the correspondence between the steering wheel angle and the road wheel angle is restored, that is to say returned to the transmission ratio of the normal operating mode, in smooth and continuous fashion. The transitions between the adapted control signals and the control signals of the normal operating mode are smoothed, such that the driving feel is more intuitive for the driver. Overall, this ensures a more uniform and more predictable steering behavior of the steering wheel relative to the steerable road wheels, thus increasing driver comfort.

For example, the first measured variable may be a road wheel angle of a steerable road wheel, and/or a detected toothed rack position of a toothed rack which is coupled at least indirectly to a steerable road wheel, and/or a pinion position of a pinion coupled to the RWA. The first measured variable is a parameter which is influenced by the torque output by the RWA. The road wheel angle may be measured by a wheel angle sensor and transmitted to the control device. The toothed rack position may be detected by a toothed rack sensor and transmitted to the control device. The pinion position may be detected by a position encoder or a position sensor and transmitted to the control device.

In one example, the control device may take the compensation phase into account only after:
expiration of a predefined time interval since the first adapted control signal resulting from a single driving mode change, and/or
determination that a stability criterion of the vehicle has been satisfied.

The predefined time interval ensures that the steering system does not permanently remain in the adapted mode, such that the long-term performance and reliability of the steering system are increased. On the basis of the stability criterion, the steering system returns to the normal mode only when the vehicle is stable, that is to say can be reliably controlled by the driver.

In some examples, the stability criterion may comprise that:
a detected steering wheel angle is smaller than an angle threshold value, and/or
a detected steering wheel speed is lower than a speed threshold value, and/or
a detected yaw rate of the vehicle about a vehicle vertical axis is lower than a threshold yaw rate.

Precise monitoring of the driving dynamics is thereby ensured, which indicates when the lateral guidance is such that a return can be made to the normal operating mode. As a result, vehicle stability and control are improved.

According to one example, the vehicle may have a user interface, for example an infotainment system, which is coupled to the control device of the steering system. By the user interface, notifications can be output by the control device to the driver of the vehicle, and user inputs can be received by the control device. This can, for example, increase the information content for the driver of the vehicle.

In one example, the control device can receive from the user interface a user input made by the driver of the vehicle indicating that the driver wishes to take control of the steering by the steering wheel, which equates to a change of driving mode. This user input can be taken into account by the control device as an indication that control of the steering is to be transferred to the driver of the vehicle.

According to a further aspect, examples disclosed herein also relate to a computer program product comprising commands which, when the computer program product is executed by a processor, cause said processor to carry out the previously described method at least in part, in particular the computation and output steps. The advantages achieved by the method described herein are also achieved correspondingly by the computer program product.

According to an additional aspect, examples disclosed herein also relate to a computer-readable storage medium comprising commands which, when the computer program product is executed by a processor, cause said processor to carry out the previously described example method at least in part, in particular the computation and output steps. The advantages achieved by the method described herein are also achieved correspondingly by the computer-readable storage medium.

According to a further aspect, examples disclosed herein can be advantageously implemented in a steering system for a vehicle. The steering system has at least an RWA, an FBA, a steering wheel, a steering wheel sensor, and a control device coupled to the RWA, to the FBA and at least indirectly to the steering wheel. In turn, the control device is configured:
to determine or receive a change of driving mode in which control of the steering by the steering wheel is to be transferred from a driving control device to a driver of the vehicle or is taken over by the driver,
to output a control signal, which has been adapted in relation to a normal operating mode of the steering system, to an electric motor of the RWA such that a steering command imparted by the steering wheel, or a change in steering command, results in a smaller road wheel angle in relation to the normal operating mode, or a reduced change in road wheel angle, of a steerable road wheel of the vehicle, and/or
to output a control signal, which has been adapted in relation to a normal operating mode of the steering system, to an electric motor of the FBA such that a steering command imparted by the steering wheel, or a change in steering command, results in an increased feedback torque in relation to the normal operating mode, or an increased change in feedback torque, at the steering wheel.

The advantages achieved by the example method are also achieved correspondingly by the steering system. A steering system is thus created in which the transition during a driving mode change is such that counter-movements by the driver are reduced, or the steering commands imparted by the driver have less of an effect. Consequently, the difference between the actual vehicle trajectory and the desired vehicle trajectory can be reduced. The operating efficiency of the vehicle is thus increased, and the steering system is configured to more precisely follow the steering commands imparted by the driver. Owing to the reduced difference with regard to the trajectory, the steering system allows increased running smoothness, such that comfort for the driver is increased.

In some examples, the steering wheel sensor is optionally configured to detect a steering wheel angle and/or a steering wheel speed, and to transmit same to the control device. The precision and responsiveness of the steering system with regard to the steering command are thus increased, allowing more precise lateral guidance of the vehicle.

Preferably, the steering system has or is coupled to a hand detection sensor (hereinafter referred to as HOOD sensor for “hands on/off detection”). A change of driving mode can, thus, not only be initiated by the control device of the steering system, but can also be identified as soon as the driver takes over control of the steering by grasping the steering wheel. Furthermore, it is thus possible to dispense with an operator control element, such as a pushbutton, which would otherwise be required for indicating a desired driving mode change.

HOOD sensors are utilized to detect hand contact of the driver with the steering wheel. Hand contact may be determined for example by torque monitoring with regard to the torque acting on the steering wheel. For this purpose, a torque sensor may be used which is coupled at least indirectly to the steering wheel, for example via a steering column on which the steering wheel is mounted.

In an alternative example, the steering wheel has internal electrodes. In particular, hand contact leads to a change in the capacitance conditions of the steering wheel electrodes. It is, thus, possible to reliably identify whether the driver has made contact with the steering wheel. Further, it is possible for the control device to determine on the basis of the hand contact signal whether the driver of the vehicle has taken over control of the steering by the steering wheel. In addition, the control device can thus also determine whether the driver is causing a movement of the steering wheel.

In an alternative example, the control device may also determine the hand contact independently, for example on the basis of a software function which may be model-based or based on an estimation algorithm. Furthermore, alternative sensor data may also be used to determine the hand contact, for example sensors such as cameras which collect vehicle interior data.

In some examples, the steering system is a steer-by-wire (SBW) steering system, an active steering system, such as an active front steering (AFS) steering system, or an electric power steering (EPS) system. Flexibility and adaptability of the steering system to different vehicle types and driving requirements are thus ensured, such that the variability and the number of possible use cases can be increased.

According to a further example, examples disclosed herein advantageously provide a steering system as described above. The advantages achieved by the steering system are also achieved correspondingly by the vehicle.

In the context of the disclosure, vehicles may in particular encompass land vehicles, namely, inter alia, off-road and road vehicles such as passenger cars, buses, trucks and other utility vehicles. Motor vehicles may be manned or unmanned. The vehicles may have an internal combustion engine, alternatively may have an electric motor for propulsion, or may be hybrid vehicles.

All of the features mentioned below with respect to the examples disclosed herein and/or the accompanying figures may be combined individually or in any sub-combination with features of examples disclosed herein, including features of preferred examples.

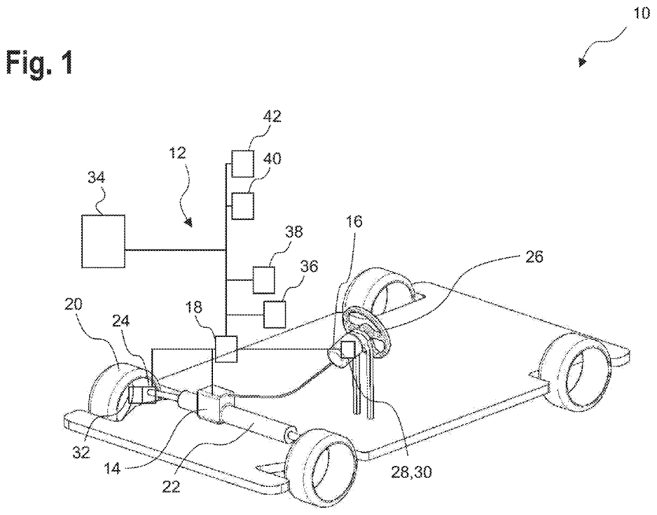

FIG. 1 shows a vehicle 10 having a steering system 12 according to examples disclosed herein. The example steering system 12 is designed here, for example, as an SBW steering system. The steering system 12 may however also be configured, alternatively or in part, as an AFS steering system or as an EPS steering system, for example.

The example steering system 12 comprises an RWA 14. The steering system 12 also comprises an FBA 16 and a control device 18. The FBA 16 and the RWA 14 are coupled together.

According to this example, the steering system 12 has only a single control device 18. In general, however, the RWA 14 and the FBA 16 may each have separate control devices 18 that control the associated actuator.

According to the illustrated example of FIG. 1, the RWA 14 is indirectly coupled to steerable road wheels 20 of the vehicle 10. For this purpose, the RWA 14 according to the present example has an electric motor which is coupled to a toothed rack 22. The RWA 14 can output a torque by the electric motor to vary a position of the toothed rack 22 along the toothed rack travel.

The toothed rack 22 is coupled to the steerable road wheels 20 of the vehicle 10. The movement of the toothed rack 22 in relation to a reference position, such as a zero position (straight-ahead position), results in a change in the orientation of the steerable road wheels 20 about the wheel steering axes of the respective road wheels 20.

The example steering system 12 has a road wheel angle sensor 24 which is designed to detect a road wheel angle of the steerable road wheels 20 about the respective wheel axes and to transmit same to the control device 18.

In an alternative example, instead of a road wheel angle sensor 24, the steering system 12 may have a toothed rack sensor that detects a position of the toothed rack 22 relative to a reference position. Since the toothed rack 22 is coupled to the steerable road wheels 20, a deflection of the toothed rack 22 causes the steerable road wheels 20 to rotate about the respective wheel steering axes. The orientation of the steerable road wheels 20 can, therefore, be determined from the detected toothed rack position, in particular by the control device 18 of the steering system 12.

In a further alternative example, instead of a road wheel angle sensor 24, use may also be made of a pinion sensor which indicates the position and/or orientation of a pinion which is at least indirectly coupled to the RWA 14. The pinion rotates about an axis of rotation in accordance with the torque which is output by the RWA 14. Since the pinion is also indirectly coupled to the steerable road wheels 20, the orientation and/or position of the pinion can be used to infer the orientation of the steerable road wheels 20.

It is self-evidently also possible for a plurality of sensor units to jointly form one sensor, allowing mutual plausibility checks and redundancy.

The example steering system 12 also has a steering wheel 26 to which the FBA 16 is coupled at least indirectly, for example via a steering column. The FBA 16 also has an electric motor. By the electric motor, the FBA 16 can apply to the steering wheel 26 a torque which influences the steering wheel angle and/or steering wheel speed, for example on the basis of an adjustment signal of the control device 18.

The FBA 16 is designed in particular to apply a feedback torque to the steering wheel 26 such that the driver of the vehicle 10 is given a feel for the lateral guidance of the vehicle 10.

The FBA 16 is also configured to generate, by the electric motor, a damping torque with respect to the steering wheel 26. The damping torque may also be regarded as part of the feedback torque.

The driver of the vehicle 10 can impart steering commands for the vehicle 10 by the steering wheel 26.

The steering system 12 also comprises at least one steering wheel sensor 28 which is configured to detect a steering wheel angle, that is to say a steering wheel position, of the steering wheel 26 in relation to a reference position, for example a central position (zero position). The steering wheel sensor 28 can consequently be utilized to detect steering commands imparted by the driver of the vehicle 10 on the basis of the steering wheel 26. In this respect, a specific present steering wheel angle and a steering wheel speed are defined by a steering command.

According to this example, the vehicle 10 also has a HOOD sensor 30, which according to this example is indirectly coupled to the steering wheel 26. The HOOD sensor 30 comprises a torque sensor which is coupled to the steering column on which the steering wheel 26 is mounted. In the event of hand contact, that is to say when the driver grasps the steering wheel 26, the driver applies a torque to the steering column, and this can be detected by the torque sensor. This allows the HOOD sensor 30 to determine, based on the driver's contact with the steering wheel 26, that the driver has taken over control of the steering by the steering wheel 26. The HOOD sensor 30 then transmits the detected hand contact to the control device 18.

In one alternative example, the control device 18 may be configured to determine hand contact, for example on the basis of additional sensor signals, for example from interior sensors or capacitance-based sensors, which are in part incorporated into the steering wheel 26, or by an estimation algorithm or a model-based software function.

Although hand contact is described here, contact may self-evidently also be detected or determined on the basis of another, preferably uncovered, part of the body.

A present steering command imparted by the steering wheel 26 generally corresponds to a specific present road wheel setpoint angle according to which the steerable road wheels 20 are to be oriented. Since the road wheels 20 are at least indirectly coupled to the toothed rack 22, a steering command is equivalent to a specific toothed rack position of the toothed rack 22, in accordance with which the toothed rack 22 is to be moved in order that a desired orientation of the road wheels 20 is set. Alternatively, the steering command corresponds to a specific position and/or orientation of a pinion coupled to the RWA 14.

By changing the steering wheel position, the driver dynamically changes the present steering command, which in turn results in a dynamic change in the toothed rack position. Furthermore, on the basis of the orientation of the steerable road wheels 20 or on the basis of the toothed rack position of the toothed rack 22, a feedback torque is determined which is to be applies by the FBA 16 to the steering wheel 26. On the basis of the feedback torque, it is sought to give the driver a feel for the lateral guidance of the vehicle 10.

According to examples disclosed herein, the dependence of the toothed rack position (road wheel angle/pinion orientation) on the present steering command in the form of the present steering wheel angle and/or the steering wheel speed is taken into account by the control device 18 in the context of a steering ratio. The steering ratio therefore describes how the road wheel angle and/or the toothed rack position and/or the pinion orientation varies dynamically in accordance with the steering wheel angle and/or the steering wheel speed and vice versa. The steering ratio is generally variable (variable steering ratio), that is to say it can have different dependency ratios for different parameter ranges. For example, particularly for small deflections of the steering wheel 26 from the reference position (straight-ahead position), the road wheel angle may be linearly dependent on the deflection of the steering wheel 26. For greater deflections of the steering wheel 26 in relation to the reference position, a transition to a non-linear dependency ratio may generally be taken into account.

According to this example, the steering wheel sensor 28 is integrated into the FBA 16. In other examples, however, the steering wheel sensor 28 may be separate from the FBA 16. The steering wheel sensor 28 is configured so as to transmit the detected steering wheel angle to the control device 18.

The example control device 18 of the steering system 12 is also configured so as to output corresponding control signals to the electric motor of the RWA 14 or to a converter coupled thereto. To execute the corresponding control routines, the control device 18 may take into account further parameters of the vehicle 10, for example the vehicle speed.

Optionally, in some examples, to detect the vehicle speed, the vehicle 10 has a speed sensor 32 which is configured to detect the vehicle speed and transmit same to the control device 18. The speed sensor 32 may be based, for example, on rotation rate sensors, which detect the rotational speeds of respectively assigned road wheels 20. This can also be used to determine wheel-specific slip.

To control the orientation of the steerable road wheels 20, the control device 18 outputs a control signal to the electric motor of the RWA 14 or to a converter coupled thereto. The control signal causes the electric motor of the RWA 14 to provide an output torque to orient the steerable road wheels 20 accordingly. The output torque from the electric motor of the RWA 14 may also be applied to the toothed rack 22 rather than directly to a road wheel 20, such that an orientation of the steerable road wheels 20 is varied indirectly.

For the various functionalities relating to the FBA 16 and the RWA 14, to influence the road wheels 20 or apply a torque to the steering wheel 26, it is self-evidently also possible for separate partial control devices to be provided, which are each individually assigned to the FBA 16 or to the RWA 14. By contrast to this, only a common single control device 18 of the steering system 12 is used here.

The road wheel angle sensor 24 detects a road wheel angle of the steerable road wheels 20 and transmits the detected road wheel angle to the control device 18. Taking into account the steering ratio, the control device 18 determines a corresponding feedback torque, which is output to the steering wheel 26. In an alternative, instead of the road wheel angle, it is also possible for the toothed rack position of the toothed rack 22 to be detected by a corresponding toothed rack sensor and taken into account, or for a pinion orientation of a pinion coupled to the RWA 14 to be detected by a pinion sensor and taken into account.

According to this example, the vehicle 10 comprises a driving control device 34. The driving control device 34 is configured to perform autonomous or partially autonomous driving functionalities. For example, the driving control device 34 can autonomously influence the lateral guidance of the vehicle 10 in this way. For this purpose, the driving control device 34 may for example provide a command for the steering wheel angle, the steering wheel movement or a corresponding parameter, which is subsequently set accordingly by the control device 18 and/or the FBA 16 of the steering system 12. The steering wheel angle that is then set is detected by the steering wheel sensor 28 and transmitted to the control device 18, or is transmitted directly from the driving control device 34 to the control device 18 and/or to the RWA 14. The driving control device 34 also receives the measurement data from the various sensors, that is to say the road wheel angle sensor 24, the steering wheel sensor 28 and the HOOD sensor 30.

If the driving control device 34 has control of the steering, then, in accordance with some driving functionalities of the driving control device 34, no steering commands need to be imparted by the driver. If the driver takes over control of the steering by grasping the steering wheel 26, control of the steering is transferred to the driver. A change of driving mode is then present.

In some examples, the vehicle 10 also comprises surroundings sensors 36 of an advanced driver assistance system. The surroundings sensors 36 are configured to detect surroundings data relating to the surroundings of the vehicle 10, for example driving surface conditions, and to transmit same to the control device 18 of the steering system 12 and/or to the driving control device 34. The surroundings sensors 36 may in particular be radar sensors, lidar sensors, camera sensors, infrared sensors or combinations thereof. The measurement data detected by the surroundings sensors 36 are taken into account by the control device 18 of the steering system 12, and/or by the driving control device 34, when performing the functions.

In addition, according to this example, the control device 18 of the steering system 12 is coupled to a memory device 38 (data memory), in which control parameters and/or vehicle parameters, for example different parameterization curves corresponding to different steering ratios, are stored.

Furthermore, the control device 18 of the steering system 12 according to this example is coupled to a low-pass filter 40. The low-pass filter 40 can be used to create a time delay with regard to specific signals during the signal processing, for example so as to cause fewer pulse-type signal responses.

The steering system 12 according to this example additionally has or is coupled to a yaw rate sensor 42. The yaw rate sensor 42 is configured to detect a yaw rate of the vehicle 10 about a vehicle vertical axis and transmit same to the control device 18 and/or to the driving control device 34.

The steering system 12 may self-evidently also have a plurality of similar and generally functionally identical components, for example a plurality of steering wheel sensors 28, thereby ensuring redundancy.

The steering system 12 is illustrated here as front axle steering system. The vehicle 10 and the steering system 12 may optionally also have further steerable road wheels 20, for example rear wheels, which are coupled to an additional common or separate RWA 14.

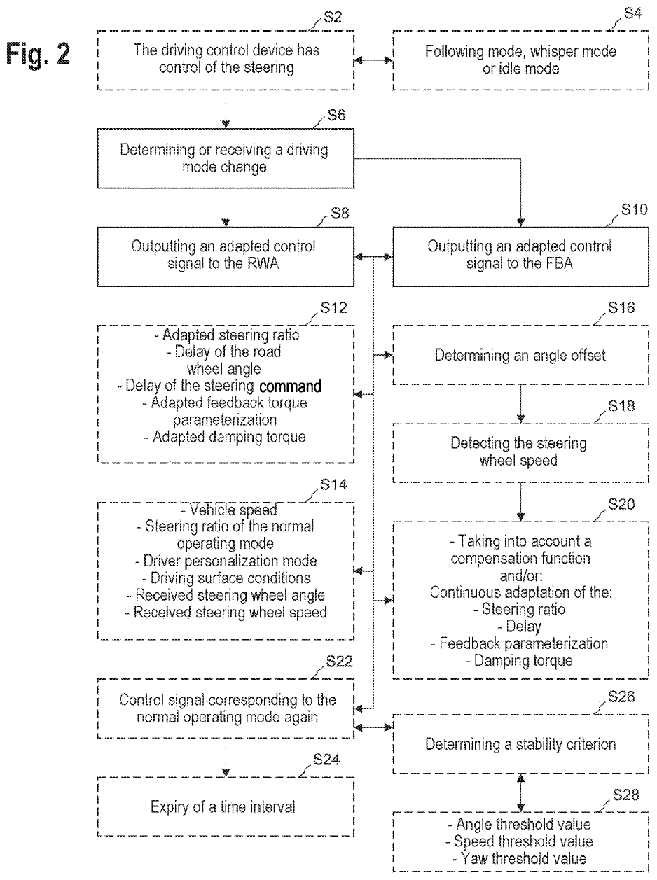

FIG. 2 is a schematic illustration of a method according to an example implementation for operating the steering system 12 for the vehicle 10. Optional steps are illustrated using dashed lines.

According to the optional step S2, the driving control device 34 has control of the steering by the steering wheel 26. This means that the driving control device 34 performs autonomous or partially autonomous driving functionalities and effects the lateral guidance of the vehicle 10. Since, in this example, the driver of the vehicle 10 does not have control of the steering by the steering wheel 26, an offset between the steering wheel angle of the steering wheel 26 and the road wheel angle of a steerable road wheel 20 can generally occur in this case. The orientation of the steering wheel 26 then deviates from the orientation that the steering wheel 26 should actually assume at this point in time in view of the road wheel angle, giving rise to an angle offset.

The offset can occur particularly if the optional step S2 is further developed by the optional step S4.

In the optional step S4, the driving control device 34 or the steering system 12 itself can move the steering wheel 26 in accordance with a whisper mode, for example using the control device 18. In whisper mode, the steering wheel 26 is generally moved in accordance with the detected road wheel angle (or toothed rack position) of at least one steerable road wheel 20, taking into account the steering ratio of the normal operating mode of the steering system 12. However, in this case, the driving control device 34 or the steering system 12 takes into account a reduction factor which is less than 1. As a result, the movement of the steering wheel 26 is reduced in amplitude compared to the dynamics of the detected first measured variable (road wheel angle, toothed rack position or pinion orientation). This gives rise to an (angle) offset between the steering wheel angle and the road wheel angle.

However, in the optional step S4, an offset occurs even if the driving control device 34 or the steering system 12 does not move the steering wheel 26 at all, in accordance with an idle mode. The idle mode can be implemented by the driving control device 34 or the steering system 12 for example for driving functionalities for which a high degree of autonomy is allowed. If the degree of autonomy is so high that the driver of the vehicle 10 is allowed to take their eyes off the road, the movement of the steering wheel 26 can be prevented by the driving control device 34 or the steering system 12, thus preventing the driver of the vehicle 10 from being influenced by a corresponding movement of the steering wheel 26. In particular, in the idle mode, the steering wheel 26 may be oriented in accordance with a straight-ahead direction. The idle mode also gives rise to an (angle) offset between the steering wheel angle and the road wheel angle.

In the optional step S4, the steering wheel 26 may also be moved by the driving control device 34 or the steering system 12 in accordance with a following mode. In the following mode, the steering wheel angle of the steering wheel 26 corresponds to the detected first measured variable (road wheel angle, toothed rack position or pinion orientation), taking into account the steering ratio, on the basis of a control signal which is output by the control device 18 to the electric motor of the FBA 16. This means that no offset occurs. Although the following mode does not generate an offset, it is relevant insofar as the initial steering input made by the driver after they take over manual control of the steering is dampened in this case too.

The offset that is caused by the autonomous or partially autonomous driving functionality of the driving control device 34 is not addressed by the present method. For example, the steps S16 to S20 are not aimed at reducing this offset.

Following the optional step S2, the method comprises step S6. In step S6, the control device 18 detects, receives or determines a change of driving mode in which control of the steering by the steering wheel 26 is to be transferred from the driving control device 34 to a driver of the vehicle 10 or is taken over by the driver. For example, a user input may be made by the driver of the vehicle 10 via a user interface to indicate a desire to take over control of the steering by the steering wheel 26. In an alternative, the HOOD sensor 30 can detect hand contact by the driver of the vehicle 10. The detected hand contact can result in the outputting of a hand detection signal by the HOOD sensor 30, said signal being used by the control device 18 in order to determine that control of the steering by the steering wheel 26 is being taken over by the driver of the vehicle 10. Alternatively, the control device 18 may also independently determine that the driver takes over control of the steering, for example on the basis of alternative sensor data.

The example method subsequently comprises at least one of the steps S8 and S10, optionally also both.

In step S8, according to examples disclosed herein, the control device 18 outputs a control signal, which has been adapted in relation to a normal operating mode of the steering system 12, to the electric motor of the RWA 14. The adapted control signal is provided by the control device 18 such that a steering command imparted by the steering wheel 26, or a change in steering command, results in a smaller road wheel angle in relation to the normal operating mode, or a reduced change in road wheel angle, of a steerable road wheel 20 of the vehicle 10. This means that, in relation to the normal operating mode of the steering system 12, a specific steering command imparted by the steering wheel 26 has a lesser effect with regard to the actual lateral guidance of the vehicle 10.

In step S10, the control device 18 outputs a control signal, which has been adapted in relation to a normal operating mode of the steering system 12, to an electric motor of the FBA 16. The adapted control signal is such that a steering command imparted by the steering wheel 26, or a change in steering command, results in an increased feedback torque in relation to the normal operating mode, or an increased change in feedback torque, at the steering wheel 26. The feedback torque gives the driver a feel for the lateral guidance of the vehicle. This is increased in magnitude by the adapted control signal so as to result in more moderate steering inputs being made by the driver.

Irrespective of which device(s) the control device outputs an adapted control signal to, the method achieves a reduced path difference between the actual vehicle trajectory and the desired trajectory of the vehicle 10.

The optional steps S8 and S10 may be further developed in different ways.

For example, the optional step S12 may be taken into account by virtue of the control device 18, when determining and outputting the adapted control signal, taking into account at least one of:
a steering ratio which has been adapted in relation to the normal operating mode, and/or
a time delay of the road wheel angle, corresponding to the steering command, of the steerable road wheel 20, and/or
a time delay of the imparted steering command, and/or
a feedback torque parameterization which has been adapted in relation to the normal operating mode, and/or
a damping torque, which is additional or has been adapted in relation to the normal operating mode, at the steering wheel 26.

The adapted steering ratio describes a divergent ratio between the steering command imparted by the steering wheel 26 and the road wheel angle, resulting from the steering command, of the steerable road wheels 20. For this purpose, divergent data sets may for example be read out of the memory device 38. In particular, the adapted steering ratio may be less direct than the steering ratio of the normal operating mode of the steering system 12. The adapted steering ratio may lead to an offset between the steering wheel angle and the road wheel angle in relation to the normal operating mode. This offset may be compensated for or at least reduced by the optional steps S16 the S20.

The time delay may be achieved for example by the low-pass filter 40. Irrespective of what the time delay relates to, the time delay leads to less abrupt changes, such that the lateral guidance and the feedback relating thereto are smoother.

The divergent feedback torque parameterization may for example also be read out of the memory device 38. The adapted feedback torque parameterization may also lead to an increased feedback torque at the steering wheel 26, whereby the steering inputs made by the driver are diminished.

The adapted damping torque may directly counteract the steering command imparted by the driver via the steering wheel 26. The driver must therefore apply a higher torque to the steering wheel 26 for the same steering command compared to the case of the non-adapted damping torque. The adapted damping torque acts as an increased resistance to rotation of the steering wheel 26. The steering commands imparted by the driver are thus intuitively diminished.

According to the optional example step S14, the control device 18 of the steering system 12, when determining and outputting the adapted control signal, takes into account the speed of the vehicle 10, which is detected for example by the speed sensor 32. The lateral guidance of the vehicle 10 can thus be coordinated with the characteristics of the vehicle 10 in the particular driving situation.

Alternatively or additionally, in the optional example step S14, the control device 18 may also take into account the steering ratio of the normal operating mode of the steering system 12. The steering feel for the driver can thus be approximated to the steering feel of the normal operating mode.

Alternatively or additionally, in the optional example step S14, the control device 18 may also take into account a driver personalization function of the steering system 12. Personal settings and preferences can thus be taken into account.

Alternatively or additionally, in the optional example step S14, the control device 18 may also take into account the driving surface conditions experienced by the vehicle 10. For example, the steering feel may be configured differently on a loose driving surface such as sand or gravel than on asphalt or concrete.

Alternatively or additionally, in the optional example step S14, the control device 18 may also take into account the steering wheel angle and/or the steering wheel speed of the steering wheel 26. For this purpose, the steering wheel angle and/or the steering wheel speed of the steering wheel 26 may be detected by the steering wheel sensor 28 and transmitted to the control device 18. For example, the command for the road wheel angle of the steerable road wheel 20 can, thus, be more precisely aligned with the steering command.

According to this example, the method also comprises the optional example steps S16 to S20 to adapt the steps S8 and/or S10.

According to the optional example step S16, in some examples, the control device 18, after outputting an adapted control signal, takes into account a compensation phase in which an offset caused by the adapted control signal, if it is based on an adapted steering ratio from step S12, is compensated for or at least reduced.

The control signal of the compensation phase constitutes an intermediate state between the adapted control signal and the control signal of the normal operating mode. For this purpose, the control device 18 determines an (angle) offset between the detected steering wheel angle of the steering wheel 26 and the road wheel angle of at least one steerable road wheel 20 which is at least indirectly coupled to the RWA 14. The road wheel angle is dependent on the detected first measured variable (road wheel angle, toothed rack position or pinion orientation) taking into account the steering ratio.

In the subsequent optional example step S18, the steering wheel speed of the steering wheel 26 caused by the steering wheel movement is detected by the steering wheel sensor 28 and transmitted to the control device 18.

The control signal of the compensation phase may subsequently be configured differently according to the optional step S20.

For example, for the compensation phase, the control device 18 may output a control signal to an electric motor of the RWA 14 such that the determined offset is compensated for, on the basis of a compensation function dependent on the detected steering wheel speed, during a movement of at least one steerable road wheel 20 caused by the steering wheel movement. This means that the steerable road wheel 20 is rotated overproportionally or underproportionally in relation to the steering wheel movement such that the angle offset caused by the differences between adapted steering ratio and steering ratio of the normal operating mode is compensated for.

Alternatively or additionally, during the compensation phase, the control device 18 may change the adapted steering ratio in a relatively continuous manner to the steering ratio of the normal operating mode.

In a further alternative example or in addition thereto, during the compensation phase, the control device 18 may change a time delay taken into account for the adapted control signal in a relatively continuous manner to a target value of the time delay of the normal operating mode.

Alternatively or additionally, during the compensation phase, the control device 18 may change the adapted feedback torque parameterization in continuous fashion to the feedback torque parameterization of the normal operating mode.

In a further example, during the compensation phase, the control device 18 may change an adapted damping torque in continuous fashion to a damping torque of the normal operating mode.

In addition, the method may be further developed to include the optional steps S22 to S28.

According to the optional example step S22, the control device 18 takes into account the compensation phase and the corresponding adaptation of the control signal only after a predefined condition is met. The control device 18 thus initiates a return to a control signal according to the normal operating mode for an electric motor of the RWA 14 and/or of the FBA 16. The steering system 12 can thus be returned to the normal operating mode such that the driver once again experiences the familiar and conventional lateral guidance of the vehicle 10.

The optional example step S22 may for example be initiated by the control device 18, that is to say the compensation phase begins only when, according to the optional step S24, a predefined time interval has elapsed since the first adapted control signal resulting from a single driving mode change. Particularly compact control is thus made possible.

The optional example step S22 may also be initiated by the control device 18, that is to say that compensation phase begins only when the control device 18 determines, according to the optional step S26, that a specific stability criterion of the vehicle 10 relating to the lateral guidance has been satisfied.

The optional step S26 may be further developed by the optional step S28. Accordingly, the stability criterion may be satisfied for example if:
a detected steering wheel angle is smaller than a predefined angle threshold value, and/or
a detected steering wheel speed is lower than a predefined speed threshold value, and/or
a detected yaw rate of the vehicle 10 about a vehicle vertical axis is lower than a predefined threshold yaw rate.

The steering wheel angle and the steering wheel speed may be detected by the steering wheel sensor 28. The yaw rate may be detected by a yaw rate sensor 42 coupled to the control device 18. Alternatively, the control device 18 may be configured to determine the yaw rate of the vehicle 10, for example on the basis of wheel-specific slip.

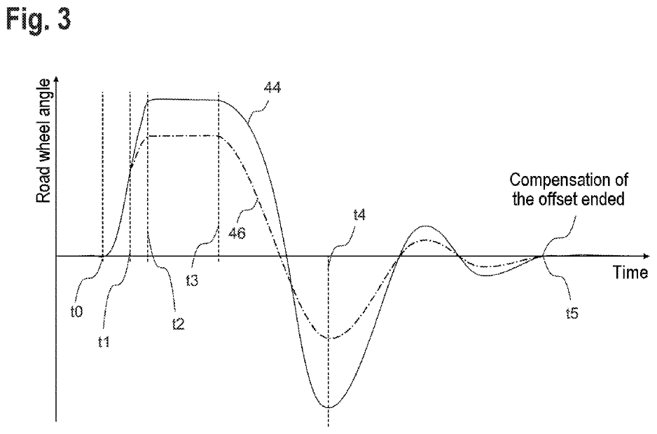

FIG. 3 is a schematic illustration of a progression of the road wheel angle of a steerable road wheel 20 during the course of the method according to examples disclosed herein. The road wheel angle of at least one steerable road wheel 20 is plotted on the y-axis versus the time on the x-axis.

At the time t0, the vehicle control device 34 steers the vehicle 10 autonomously. Consequently, the driving control device 34 outputs control signals to the control device 18 and/or the FBA 16 and/or the RWA 14, firstly, to control the steerable road wheels 20 in accordance with the autonomously determined steering command, and to hold the steering wheel 26 stationary despite the lateral guidance of the vehicle 10, in accordance with the idle mode.

At the time t1, the driver takes over control of the steering of the vehicle by the steering wheel 26, such that a driving mode change is present, see steps S6 and S8. If the lateral guidance of the vehicle 10 were continued in accordance with the steering ratio of the normal operating mode, the result would be the progression 44 of the road wheel angle of the steerable road wheel 20.

According to this example, however, the control device 18 adapts the control signal such that a control signal adapted in relation to the normal operating mode of the steering system 12 is output to the RWA 14. For this purpose, the control device 18 takes into account a steering ratio which has been adapted in relation to the normal operating mode of the steering system 12. The adapted steering ratio is less direct than the steering ratio of the normal operating mode, such that the same steering command results in a reduced change in the road wheel angle of the steerable road wheel 20. The result is lateral guidance of the vehicle 10 in accordance with the adapted steering ratio, resulting in the adapted progression 46 of the road wheel angle of the steerable road wheel 20. The deviation of the road wheel angle in relation to the normal operating mode is consequently reduced. In turn, the adapted steering ratio causes an offset relative to the progression of the normal operating mode, said offset subsequently being reduced in continuous fashion.

In relation to the steering ratio of the normal operating mode, the change to a less direct steering ratio leads to smoother and reduced reactions of the road wheel angle of the steerable road wheel 20 in response to the steering commands by the driver via the steering wheel 26, see the time t2.

At the time t3, the driver begins to steer the vehicle 10 back to a straight-ahead position. The driver however reacts excessively, that is to say overcorrects the road wheel angle of the steerable road wheel 20. Owing to the adapted steering ratio, it is also the case in this phase that the movement of the steering wheel 26 leads to a reduced road wheel angle of the steerable road wheel 20 in relation to the steering ratio of the normal operating mode.

At the time t4, an overreaction of the driver has had the effect that the road wheel angle of the steerable road wheel 20 has gone beyond the straight-ahead direction. The adapted, less direct steering ratio in relation to the steering ratio of the normal operating mode nevertheless has the effect that the difference between the actual vehicle trajectory corresponding to the adapted control signal and the desired vehicle trajectory corresponding to the straight-head direction is less than it would be if the steering ratio of the normal operating mode continued to be taken into account by the control device 18.

Consequently, by the control device 18 and on the basis of the method, the vehicle 10 is steered, with reduced path differences, back to the desired trajectory. The lateral guidance of the vehicle 10 thus exhibits fewer disturbances, such that the operating efficiency of the steering system 12 and of the vehicle 10, and driver comfort, are increased.

At the time t5, the vehicle 10 is once again traveling straight. At this time, the adapted control signal can be changed by the control device 18 back to the control signal of the normal operating mode, by virtue of the steering ratio of the normal operating mode being applied again, see step S16.

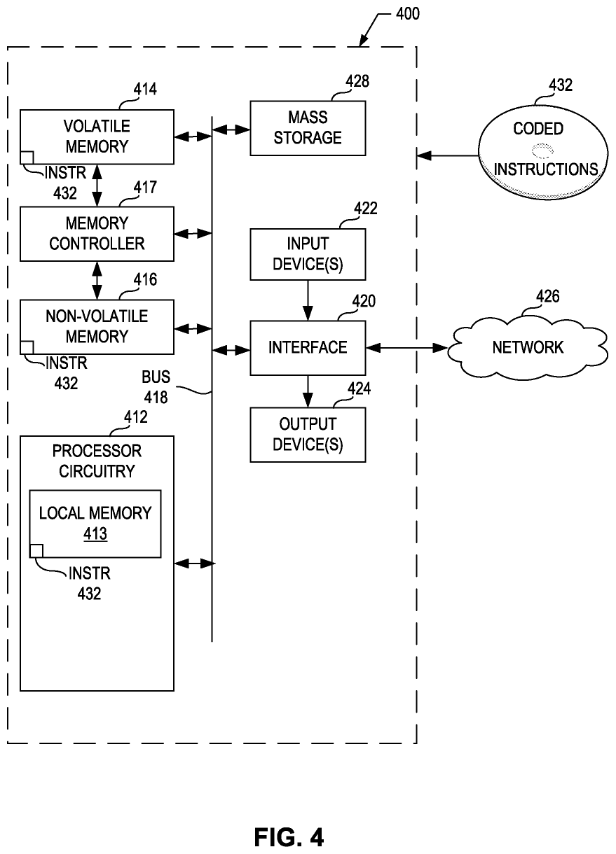

FIG. 4 is a block diagram of an example programmable circuitry platform 400 structured to execute and/or instantiate the example machine-readable instructions and/or the example operations of FIG. 2 to implement examples disclosed herein. The programmable circuitry platform 400 can be, for example, a control device, an electronic control unit (ECU), a self-learning machine (e.g., a neural network), or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 412 may be implemented by one or more semiconductor based (e.g., silicon based) devices.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416.

The programmable circuitry platform 400 of the illustrated example also includes interface circuitry 420. The interface circuitry 420 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, an audio sensor, a microphone, a camera (still or video), a button, a touchscreen, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 432, which may be implemented by the machine-readable instructions of FIG. 2, may be stored in the mass storage device 428, in the volatile memory 414, in the non-volatile memory 416, and/or on at least one non-transitory computer readable storage medium such as a CD or DVD which may be removable.

Example methods, apparatus, systems, and articles of manufacture to enable smooth vehicle control upon transitions between autonomous and manual driving modes are disclosed herein. Further examples and combinations thereof include the following:

Example 1 includes an apparatus for operating a steering system for a vehicle, the apparatus comprising interface circuitry communicatively coupled to a sensor, machine readable instructions, and at least one programmable circuitry to execute the machine readable instructions to determine an occurrence of a change of driving mode in which control of a steering wheel is to be transferred between a driving control device and driver input, and in response to output of the sensor corresponding to a steering command imparted to the steering wheel or a change in the steering command, provide, based on the change of driving mode, a control signal that is adapted relative to a normal operating mode of the steering system to at least one of (i) a road wheel actuator to reduce a road wheel angle in relation to the normal operating mode, or (ii) a steering wheel actuator to provide an increased feedback torque in relation to the normal operating mode.

Example 2 includes the apparatus as defined in example 1, wherein one or more of the at least one programmable circuitry is to adapt the control signal based on receiving the steering command of the steering wheel, and determine the adapted control signal based on at least one of (i) a steering ratio which has been adapted in relation to the normal operating mode, (ii) a time delay of the road wheel angle, corresponding to the steering command, of a steerable road wheel, (iii) a time delay of the steering command, (iv) a feedback torque parameterization that has been adapted in relation to the normal operating mode, or (v) a damping torque, which is additional or has been adapted in relation to the normal operating mode, at the steering wheel.

Example 3 includes the apparatus as defined in example 2, wherein a time delay of the road wheel angle, which corresponds to the steering command, is filtered by a low-pass filter.

Example 4 includes the apparatus of any one or more of examples 2-3, wherein the steering ratio of the adapted control signal is less direct than a steering ratio of the normal operating mode.

Example 5 includes the apparatus of any one or more of examples 2-4, wherein the adapted control signal is based on at least one of (i) a speed of the vehicle, (ii) the steering ratio of the normal operating mode, (iii) a driver personalization function, (iv) driving surface conditions experienced by the vehicle, or (v) at least one of (a) a received steering wheel angle or (b) a received steering wheel speed of the steering wheel.

Example 6 includes the apparatus of any one or more of examples 2-5, wherein one or more of the at least one programmable circuitry is to perform a compensation phase based on an adapted steering ratio by determining an offset between a detected steering wheel angle of the steering wheel) and a road wheel angle of at least one steerable road wheel which is at least indirectly coupled to the road wheel actuator, the offset being caused by the adapted steering ratio and being dependent on a detected first measured variable that is based on a steering ratio, detecting, a steering wheel speed of the steering wheel caused by the steering wheel movement, and during the compensation phase, providing a control signal to an electric motor of the road wheel actuator such that the determined offset is compensated for based on a compensation function that is dependent on the detected steering wheel speed during a movement of at least one steerable road wheel caused by the steering wheel movement.

Example 7 includes the apparatus as defined in example 6, wherein at least one of (i) the adapted steering ratio is changed at a controlled rate to the steering ratio of the normal operating mode, (ii) a time delay for the adapted control signal is changed at a controlled rate to a target value of the time delay for the normal operating mode, (iii) an adapted feedback torque parameterization is changed at a controlled rate to a feedback torque parameterization of the normal operating mode, or (iv) an adapted damping torque is changed at a controlled rate to a damping torque of the normal operating mode.

Example 8 includes the apparatus of any one or more of examples 6-7, wherein one or more of the at least one programmable circuitry is to perform the compensation phase based on at least one of (i) expiration of a predefined time interval since the control signal has been adapted based on a single driving mode change, or (ii) a determination that a stability criterion of the vehicle has been satisfied.

Example 9 includes the apparatus as defined in example 8, wherein the stability criterion includes at least one of (i) a detected steering wheel angle is smaller than an angle threshold value, (ii) a detected steering wheel speed is lower than a speed threshold value, or (iii) a detected yaw rate of the vehicle about a vehicle vertical axis is lower than a threshold yaw rate.

Example 10 includes a method for operating a steering system for a vehicle, the method comprising determining an occurrence of a change of driving mode in which control of a steering wheel is to be transferred between a driving control device and driver input, and in response to output of a sensor corresponding to a steering command imparted to the steering wheel or a change in the steering command, providing, based on the change of driving mode, a control signal that is adapted relative to a normal operating mode of the steering system to at least one of (i) a road wheel actuator to reduce a road wheel angle in relation to the normal operating mode, or (ii) a steering wheel actuator to provide an increased feedback torque in relation to the normal operating mode.

Example 11 includes the method as defined in example 10, including adapting the control signal based on receiving the steering command of the steering wheel, and determining the adapted control signal based on at least one of (i) a steering ratio which has been adapted in relation to the normal operating mode, (ii) a time delay of the road wheel angle, corresponding to the steering command, of a steerable road wheel, (iii) a time delay of the steering command, (iv) a feedback torque parameterization that has been adapted in relation to the normal operating mode, or (v) a damping torque, which is additional or has been adapted in relation to the normal operating mode, at the steering wheel.

Example 12 includes the method as defined in example 11, including filtering, by a low-pass filter, a time delay of the road wheel angle.

Example 13 includes the method of any one or more of examples 11-12, wherein the steering ratio of the adapted control signal is less direct than a steering ratio of the normal operating mode.

Example 14 includes the method of any one or more of examples 11-13, wherein the adapted control signal is based on at least one of (i) a speed of the vehicle, (ii) the steering ratio of the normal operating mode, (iii) a driver personalization function, (iv) driving surface conditions experienced by the vehicle, or (v) at least one of (a) a received steering wheel angle or (b) a received steering wheel speed of the steering wheel.

Example 15 includes the method of any one or more of examples 11-14, including performing a compensation phase based on an adapted steering ratio by determining an offset between a detected steering wheel angle of the steering wheel and a road wheel angle of at least one steerable road wheel which is at least indirectly coupled to the road wheel actuator, the offset being caused by the adapted steering ratio and being dependent on a detected first measured variable that is based on a steering ratio, detecting a steering wheel speed of the steering wheel caused by the steering wheel movement, and providing a control signal to an electric motor of the road wheel actuator such that the determined offset is compensated for based on a compensation function that is dependent on the detected steering wheel speed during a movement of at least one steerable road wheel caused by the steering wheel movement.

Example 16 includes a non-transitory machine readable storage medium comprising instructions to cause at least one programmable circuitry to at least determine an occurrence of a change of driving mode in which control of a steering wheel of a vehicle is to be transferred between a driving control device and driver input, and in response to an output of a sensor corresponding to a steering command imparted to the steering wheel or a change in the steering command, provide, based on the change of driving mode, a control signal that is adapted relative to a normal operating mode of a steering system to at least one of (i) a road wheel actuator to reduce a road wheel angle in relation to the normal operating mode, or (ii) a steering wheel actuator to provide an increased feedback torque in relation to the normal operating mode.

Example 17 includes the non-transitory machine readable storage medium as defined in example 16, wherein the instructions cause one or more of the at least one programmable circuitry to adapt the control signal based on receiving the steering command of the steering wheel, and determine the adapted control signal based on at least one of (i) a steering ratio which has been adapted in relation to the normal operating mode, (ii) a time delay of the road wheel angle, corresponding to the steering command, of a steerable road wheel, (iii) a time delay of the steering command, (iv) a feedback torque parameterization that has been adapted in relation to the normal operating mode, or (v) a damping torque, which is additional or has been adapted in relation to the normal operating mode, at the steering wheel.

Example 18 includes the non-transitory machine readable as defined in example 17, wherein the instructions cause one or more of the at least one programmable circuitry to filter, by a low-pass filter, a time delay of the road wheel angle, which corresponds to the steering command.

Example 19 includes the apparatus of any one or more of examples 17-18, wherein the steering ratio of the adapted control signal is less direct than a steering ratio of the normal operating mode.

Example 20 includes the apparatus of any one or more of examples 17-19, wherein the control signal is adapted based on at least one of (i) a speed of the vehicle, (ii) the steering ratio of the normal operating mode, (iii) a driver personalization function, (iv) driving surface conditions experienced by the vehicle, or (v) at least one of (a) a received steering wheel angle or (b) a received steering wheel speed of the steering wheel.

What is claimed is:

1. An apparatus for operating a steering system for a vehicle, the apparatus comprising:
interface circuitry communicatively coupled to a sensor;
machine readable instructions; and
at least one programmable circuitry to execute the machine readable instructions to:
determine an occurrence of a change of driving mode in which control of a steering wheel is to be transferred between a driving control device and driver input; and
in response to output of the sensor corresponding to a steering command imparted to the steering wheel or a change in the steering command, provide, based on the change of driving mode, a control signal that is adapted relative to a normal operating mode of the steering system to at least one of:
(i) a road wheel actuator to reduce a road wheel angle in relation to the normal operating mode, or
(ii) a steering wheel actuator to provide an increased feedback torque in relation to the normal operating mode.

2. The apparatus as defined in claim 1, wherein one or more of the at least one programmable circuitry is to:
adapt the control signal based on receiving the steering command of the steering wheel; and
determine the adapted control signal based on at least one of:
(i) a steering ratio which has been adapted in relation to the normal operating mode;
(ii) a time delay of the road wheel angle, corresponding to the steering command, of a steerable road wheel;
(iii) a time delay of the steering command;
(iv) a feedback torque parameterization that has been adapted in relation to the normal operating mode; or
(v) a damping torque, which is additional or has been adapted in relation to the normal operating mode, at the steering wheel.

3. The apparatus as defined in claim 2, wherein a time delay of the road wheel angle, which corresponds to the steering command, is filtered by a low-pass filter.

4. The apparatus as defined in claim 2, wherein the steering ratio of the adapted control signal is less direct than a steering ratio of the normal operating mode.

5. The apparatus as defined in claim 2, wherein the adapted control signal is based on at least one of:
(i) a speed of the vehicle;
(ii) the steering ratio of the normal operating mode;
(iii) a driver personalization function;
(iv) driving surface conditions experienced by the vehicle; or
(v) at least one of (a) a received steering wheel angle or (b) a received steering wheel speed of the steering wheel.

6. The apparatus as defined in claim 2, wherein one or more of the at least one programmable circuitry is to perform a compensation phase based on an adapted steering ratio by:
determining an offset between a detected steering wheel angle of the steering wheel) and a road wheel angle of at least one steerable road wheel which is at least indirectly coupled to the road wheel actuator, the offset being caused by the adapted steering ratio and being dependent on a detected first measured variable that is based on a steering ratio,
detecting, a steering wheel speed of the steering wheel caused by the steering wheel movement, and
during the compensation phase, providing a control signal to an electric motor of the road wheel actuator such that the determined offset is compensated for based on a compensation function that is dependent on the detected steering wheel speed during a movement of at least one steerable road wheel caused by the steering wheel movement.

7. The apparatus as defined in claim 6, wherein at least one of:
(i) the adapted steering ratio is changed at a controlled rate to the steering ratio of the normal operating mode;
(ii) a time delay for the adapted control signal is changed at a controlled rate to a target value of the time delay for the normal operating mode;
(iii) an adapted feedback torque parameterization is changed at a controlled rate to a feedback torque parameterization of the normal operating mode; or
(iv) an adapted damping torque is changed at a controlled rate to a damping torque of the normal operating mode.

8. The apparatus as defined in claim 6, wherein one or more of the at least one programmable circuitry is to perform the compensation phase based on at least one of:
(i) expiration of a predefined time interval since the control signal has been adapted based on a single driving mode change, or
(ii) a determination that a stability criterion of the vehicle has been satisfied.

9. The apparatus as defined in claim 8, wherein the stability criterion includes at least one of:
(i) a detected steering wheel angle is smaller than an angle threshold value,
(ii) a detected steering wheel speed is lower than a speed threshold value, or
(iii) a detected yaw rate of the vehicle about a vehicle vertical axis is lower than a threshold yaw rate.

10. A method for operating a steering system for a vehicle, the method comprising:
determining an occurrence of a change of driving mode in which control of a steering wheel is to be transferred between a driving control device and driver input; and
in response to output of a sensor corresponding to a steering command imparted to the steering wheel or a change in the steering command, providing, based on the change of driving mode, a control signal that is adapted relative to a normal operating mode of the steering system to at least one of:
(i) a road wheel actuator to reduce a road wheel angle in relation to the normal operating mode, or
(ii) a steering wheel actuator to provide an increased feedback torque in relation to the normal operating mode.

11. The method as defined in claim 10, including:
adapting the control signal based on receiving the steering command of the steering wheel; and
determining the adapted control signal based on at least one of:
(i) a steering ratio which has been adapted in relation to the normal operating mode;
(ii) a time delay of the road wheel angle, corresponding to the steering command, of a steerable road wheel;
(iii) a time delay of the steering command;
(iv) a feedback torque parameterization that has been adapted in relation to the normal operating mode; or
(v) a damping torque, which is additional or has been adapted in relation to the normal operating mode, at the steering wheel.

12. The method as defined in claim 11, including filtering, by a low-pass filter, a time delay of the road wheel angle.

13. The method as defined in claim 11, wherein the steering ratio of the adapted control signal is less direct than a steering ratio of the normal operating mode.

14. The method as defined in claim 11, wherein the adapted control signal is based on at least one of:
(i) a speed of the vehicle;
(ii) the steering ratio of the normal operating mode;
(iii) a driver personalization function;
(iv) driving surface conditions experienced by the vehicle; or
(v) at least one of (a) a received steering wheel angle or (b) a received steering wheel speed of the steering wheel.

15. The method as defined in claim 11, including performing a compensation phase based on an adapted steering ratio by:
determining an offset between a detected steering wheel angle of the steering wheel and a road wheel angle of at least one steerable road wheel which is at least indirectly coupled to the road wheel actuator, the offset being caused by the adapted steering ratio and being dependent on a detected first measured variable that is based on a steering ratio;
detecting a steering wheel speed of the steering wheel caused by the steering wheel movement; and
providing a control signal to an electric motor of the road wheel actuator such that the determined offset is compensated for based on a compensation function that is dependent on the detected steering wheel speed during a movement of at least one steerable road wheel caused by the steering wheel movement.

16. A non-transitory machine readable storage medium comprising instructions to cause at least one programmable circuitry to at least:
determine an occurrence of a change of driving mode in which control of a steering wheel of a vehicle is to be transferred between a driving control device and driver input; and
in response to an output of a sensor corresponding to a steering command imparted to the steering wheel or a change in the steering command, provide, based on the change of driving mode, a control signal that is adapted relative to a normal operating mode of a steering system to at least one of:
(i) a road wheel actuator to reduce a road wheel angle in relation to the normal operating mode, or
(ii) a steering wheel actuator to provide an increased feedback torque in relation to the normal operating mode.

17. The non-transitory machine readable storage medium as defined in claim 16, wherein the instructions cause one or more of the at least one programmable circuitry to:
adapt the control signal based on receiving the steering command of the steering wheel; and
determine the adapted control signal based on at least one of:
(i) a steering ratio which has been adapted in relation to the normal operating mode;
(ii) a time delay of the road wheel angle, corresponding to the steering command, of a steerable road wheel;
(iii) a time delay of the steering command;
(iv) a feedback torque parameterization that has been adapted in relation to the normal operating mode; or
(v) a damping torque, which is additional or has been adapted in relation to the normal operating mode, at the steering wheel.

18. The non-transitory machine readable as defined in claim 17, wherein the instructions cause one or more of the at least one programmable circuitry to filter, by a low-pass filter, a time delay of the road wheel angle, which corresponds to the steering command.

19. The non-transitory machine readable as defined in claim 17, wherein the steering ratio of the adapted control signal is less direct than a steering ratio of the normal operating mode.

20. The non-transitory machine readable as defined in claim 17, wherein the control signal is adapted based on at least one of:
(i) a speed of the vehicle;
(ii) the steering ratio of the normal operating mode;
(iii) a driver personalization function;
(iv) driving surface conditions experienced by the vehicle; or
(v) at least one of (a) a received steering wheel angle or (b) a received steering wheel speed of the steering wheel.
